(19) United States
(12) Patent Application Publication
(10) Pub. No.: US 2026/0292627 A1
(43) Pub. Date: Sep. 24, 2026

(54) METHOD IN USER EQUIPMENT (UE), METHOD IN UNIFIED DATA MANAGEMENT (UDM), UE, AND UDM

(71) Applicant: NEC Corporation, Minato-ku, Tokyo (JP)

(72) Inventors: Kundan TIWARI, Bengaluru (IN); Toshiyuki TAMURA, Ibaraki (JP); Iskren IANEV, Reading (GB)

(73) Assignee: NEC Corporation, Minato-ku, Tokyo (JP)

(21) Appl. No.: 18/996,034

(22) PCT Filed: Aug. 31, 2023
(86) PCT No.: PCT/JP2023/031790

§ 371 Date: Jan. 17, 2025

(30) Foreign Application Priority Data
Sep. 7, 2022 (IN) 202211051126

(51) Int. Cl. H04W 36/08; H04W 60/04; H04W 84/04

(52) U.S. Cl. CPC H04W 36/08; H04W 60/04; H04W 84/042

(57) ABSTRACT

An aspect of this disclosure includes a method of a User Equipment (UE). The method includes communicating with a communication apparatus. The method includes receiving from the communication apparatus, first signal threshold Information and performing a PLMN selection based on the first signal threshold Information.

### TECHNICAL FIELD

The present disclosure relates to a method of a user equipment (UE), a method of a communication apparatus, a UE, and a communication apparatus.

### BACKGROUND ART

According to the 3GPP contribution SP-211068 [2], 3GPP defines a new feature called Signal Level Enhanced Network Selection in 3GPP Release 18. This feature solves the issue the VPLMN selection when the IoT devices are not on their home network. There are many cases where the IoT devices are not in the home network. For example, the modules of IoT devices are deployed in other countries than that of the provided USIMs or because of the use of Global USIMs for IoT use cases.

### SUMMARY OF INVENTION

### Technical Problem

The issue with the VPLMN selection by the IOT devices is summarized below.
During the initial steps of selecting a network after switch on or recovery from loss of coverage and during all steps of periodic re-selection, the signal level of available cells is not taken into account. Only the cell selection criteria as broadcast by the PLMN and the priority of the networks is considered for the cell reselection.
This results in UEs selecting or staying on a network on which the coverage in a particular place is poor. This happens because the UE selects a PLMN with higher priority, while other PLMNs of lower priority are available with much better local coverage. For typical consumer UEs this is no problem-due to mobility the conditions are changing quickly and there is a user who recognizes the problems and can react, e.g., by changing the location a bit or manually selection another PLMN. It is the desired behavior as part of steering of roaming and avoids frequent changes of networks. But for stationary devices without supervision by a user it can be a problem.

In order to solve this issue, the Signal Level Enhanced Network Selection feature is introduced in 3GPP Release 18. This feature allows to take the signal level into account during the initial steps of network selection after switch-on or recovery from loss of coverage and during all steps of the periodic cell re-selection and PLMN selection.

Although the requirements of the Signal Level Enhanced Network Selection feature are defined in the 3GPP TS 22.011 [6], there is no mechanism defined in any of 3GPP specifications.

For example, 3GPP TS 22.011 [6] defines the requirement for the Signal Level Enhanced Network Selection feature as follows.
For UEs supporting any, or a combination, of NB-IoT, GERAN EC-GSM-IoT and Category M1 or M2 of E-UTRA, the 5G system shall support a mechanism to have an Operator controlled signal threshold per access technology on the USIM to be used for network selection. The signal threshold is specific for a certain Access Technology and shall apply to all PLMNs with the corresponding access technology combinations.

In order to comply to this requirement, there are many aspects taken into account.

For example, there must be a mechanism that enables to transfer an information for the Operator controlled signal threshold per access technology securely from the home operator to the USIM of the IoT device. If the information for the Operator controlled signal threshold per access technology becomes available in the VPLMN where the IoT UE tunes, then the VPLMN may remove such information in order for the IoT UE to stay in that VPLMN. In this case, intended VPLMN selection cannot be achieved. As the result, the IoT UE stays with that VPLMN and suffers from poor coverage.

For example, it is unclear how the information for the Operator controlled signal threshold structures. There are many radio aspects that influence to a stable communication between the IoT UE and network. For example, signaling strength, signal quality, interference level and etc. 3GPP has to define a structure of the information for the Operator controlled signal threshold.

### Solution to Problem

Accordingly, the present disclosure seeks to provide methods and associated apparatus that address or at least alleviate (at least some of) the above-described issues.

In one aspect, the disclosure provides a user equipment (UE) including a Mobile Termination (MT) and a User Services Identity Module (USIM), the UE comprising:
a transmitter configured to transmit, to an Access and Mobility Management Function (AMF), a Registration Request message, in a case where a signal threshold per access technology is not set on the USIM or not applied by the UE, and
a receiver configured to receive, from the AMF, a Registration Accept message including information indicating the signal threshold per access technology.

In one aspect, the disclosure provides an Access and Mobility Management Function (AMF) comprising
a receiver configured to receive, from a user equipment (UE), a Registration Request message,
a transmitter configured to transmit, to the UE, a Registration Accept message including information indicating a signal threshold per access technology, the information being received from a Unified Data Management (UDM).

In one aspect, the disclosure provides a Unified Data Management (UDM) comprising:
a receiver configured to receive, from an Access and Mobility Management Function (AMF), first request message,
a transmitter configured to transmit, to a Steering Of Roaming Application Function (SoR-AF), second request message,
the receiver configured to receive, from the SoR-AF, second response message including information indicating a signal threshold per access technology, and
the transmitter configured to transmit, to the AMF, first response message including the information indicating the signal threshold per access technology.

In one aspect, the disclosure provides a method in a user equipment (UE) including a Mobile Termination (MT) and a User Services Identity Module (USIM), the method comprising:
transmitting, to an Access and Mobility Management Function (AMF), a Registration Request message, in a case where a signal threshold per access technology is not set on the USIM or not applied by the UE, and
receiving, from the AMF, a Registration Accept message including information indicating the signal threshold per access technology.

In one aspect, the disclosure provides a method in an Access and Mobility Management Function (AMF), the method comprising
receiving, from a user equipment (UE), a Registration Request message,
transmitting, to the UE, a Registration Accept message including information indicating a signal threshold per access technology, the information being received from a Unified Data Management (UDM).

In one aspect, the disclosure provides a method in an a Unified Data Management (UDM), the method comprising:
receiving, from an Access and Mobility Management Function (AMF), first request message,
transmitting, to a Steering Of Roaming Application Function (SoR-AF), second request message,
receiving, from the SoR-AF, second response message including information indicating a signal threshold per access technology, and
transmitting first response message including the information indicating the signal threshold per access technology received from the SoR-AF.

### Advantageous Effects of Invention

According to the present disclosure, a method of UE, a method of AMF, a method of UDM, UE, AMF, and UDM are provided.

### BRIEF DESCRIPTION OF DRAWINGS

The foregoing and further objects, features and advantages of the present subject matter will become apparent from the following description of exemplary embodiments with reference to the accompanying drawings, wherein like numerals are used to represent like elements.

It is to be noted, however, that the appended drawings along with the reference numerals illustrate only typical embodiments of the present subject matter, and are therefore, not to be considered for limiting of its scope, for the subject matter may admit to other equally effective embodiments.

FIG. 1 is a signaling diagram of a First example of the First Aspect.

FIG. 2 is a signaling diagram of a First example of the Second Aspect.

FIG. 3 is the existing PLMN selection diagram in 3GPP TS 23.122.

FIG. 4 is a process diagram in a UE for a Second example of the Second Aspect.

FIG. 5 is a process diagram in a UE for a Third example of the Second Aspect.

FIG. 6 is a diagram illustrating a system overview.

FIG. 7 is a block diagram illustrating a UE.

FIG. 8 is a block diagram illustrating an (R)AN node.

FIG. 9 is a diagram illustrating System overview of (R)AN node based on O-RAN architecture.

FIG. 10 is a block diagram illustrating an RU.

FIG. 11 is a block diagram illustrating a DU.

FIG. 12 is a block diagram illustrating a CU.

FIG. 13 is a block diagram illustrating an AMF.

FIG. 14 is a block diagram illustrating a PCF.

FIG. 15 is a block diagram illustrating an AUSF.

FIG. 16 is a block diagram illustrating a UDM.

FIG. 17 is a block diagram illustrating an NSSF.

### DESCRIPTION OF EXAMPLE EMBODIMENTS

### Abbreviations

For the purposes of the present document, the abbreviations given in 3GPP TR 21.905 [1] and the following apply. An abbreviation defined in the present document takes precedence over the definition of the same abbreviation, if any, in 3GPP TR 21.905 [1].

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN | 5G Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G-S-TMSI | 5G S-Temporary Mobile Subscription Identifier |
| 5G VN | 5G Virtual Network |
| 5QI | 5G QoS Identifier |
| AF | Application Function |
| AMF | Access and Mobility Management Function |
| AMF-G | Geographically selected Access and Mobility Management |
| | Function |
| AMF-NG | Non-Geographically selected Access and Mobility |
| | Management Function |
| ANDSF | Access Network Discovery and Selection Function |
| ARFCN | Absolute radio-frequency channel number |
| AS | Access Stratum |
| ATSSS | Access Traffic Steering, Switching, Splitting |
| ATSSS-LL | ATSSS Low-Layer |
| AUSF | Authentication Server Function |
| AUTN | Authentication token |
| BCCH | Broadcast Control Channel |
| BMCA | Best Master Clock Algorithm |
| BSF | Binding Support Function |
| CAG | Closed Access Group |
| CAPIF | Common API Framework for 3GPP northbound APIs |
| CHF | Charging Function |
| CN PDB | Core Network Packet Delay Budget |
| CP | Control Plane |
| DAPS | Dual Active Protocol Stacks |
| DL | Downlink |
| DN | Data Network |
| DNAI | DN Access Identifier |
| DNN | Data Network Name |
| DRX | Discontinuous Reception |
| DS-TT | Device-side TSN translator |
| ePDG | evolved Packet Data Gateway |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| GPSI | Generic Public Subscription Identifier |
| GUAMI | Globally Unique AMF Identifier |
| GUTI | Globally Unique Temporary UE Identity |
| HPLMN | Home Public Land Mobile Network |
| HR | Home Routed (roaming) |
| IAB | Integrated access and backhaul |
| IMEI/TAC | IMEI Type Allocation Code |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| MCC | Mobile country code |
| MCX | Mission Critical Service |
| MDBV | Maximum Data Burst Volume |
| ME | Mobile Equipment |
| MFBR | Maximum Flow Bit Rate |
| MICO | Mobile Initiated Connection Only |
| MITM | Man In the Middle |
| MNC | Mobile Network Code |
| MPS | Multimedia Priority Service |
| MPTCP | Multi-Path TCP Protocol |
| MT | Mobile Termination |
| N3IWF | Non-3GPP InterWorking Function |
| N3GPP | Non-3GPP access |
| N5CW | Non-5G-Capable over WLAN |
| NAI | Network Access Identifier |
| NAS | Non-Access-Stratum |
| NEF | Network Exposure Function |
| NF | Network Function |
| NGAP | Next Generation Application Protocol |
| NID | Network identifier |
| NPN | Non-Public Network |
| NR | New Radio |
| NSAG | Network Slice Access Stratum Group |
| NRF | Network Repository Function |
| NSI ID | Network Slice Instance Identifier |
| NSSAA | Network Slice-Specific Authentication and Authorization |
| NSSAAF | Network Slice-Specific Authentication and Authorization |
| | Function |
| NSSAI | Network Slice Selection Assistance Information |
| NSSF | Network Slice Selection Function |
| NSSP | Network Slice Selection Policy |
| NSSRG | Network Slice Simultaneous Registration Group |
| NW-TT | Network-side TSN translator |
| NWDAF | Network Data Analytics Function |
| PCF | Policy Control Function |
| PCO | Protocol Configuration Options |
| PDB | Packet Delay Budget |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| RACS | Radio Capabilities Signalling optimisation |
| (R)AN | (Radio) Access Network |
| RAT | Radio Access Technology |
| RG | Residential Gateway |
| RIM | Remote Interference Management |
| RQA | Reflective QoS Attribute |
| RQI | Reflective QoS Indication |
| RSN | Redundancy Sequence Number |
| RSRP | Reference Signal Received Power |
| RSRQ | Reference Signal Received Quality |
| SA NR | Standalone New Radio |
| SBA | Service Based Architecture |
| SBI | Service Based Interface |
| SCP | Service Communication Proxy |
| SD | Slice Differentiator |
| SEAF | Security Anchor Functionality |
| SENSE | Signal Level Enhanced Network Selection |
| SEPP | Security Edge Protection Proxy |
| SIB | System Information Block |
| SINR | Signal to Interference plus Noise Ratio |
| SMF | Session Management Function |
| SMSF | Short Message Service Function |
| SN | Sequence Number |
| SN name | Serving Network Name. |
| SNPN | Stand-alone Non-Public Network |
| S-NSSAI | Single Network Slice Selection Assistance Information |
| SOR | Steering of Roaming |
| SSC | Session and Service Continuity |
| SSCMSP | Session and Service Continuity Mode Selection Policy |
| SST | Slice/Service Type |
| SUCI | Subscription Concealed Identifier |
| SUPI | Subscription Permanent Identifier |
| SV | Software Version |
| TMSI | Temporary Mobile Subscriber Identity |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UE | User Equipment |
| UL | Uplink |
| UL CL | Uplink Classifier |
| UPF | User Plane Function |
| UPSI | UE Policy Section Identifier |
| URLLC | Ultra Reliable Low Latency Communication |
| URRP-AMF | UE Reachability Request Parameter for AMF |
| URSP | UE Route Selection Policy |
| USIM | User Services Identity Module |
| VID | VLAN Identifier |
| VLAN | Virtual Local Area Network |
| VPLMN | Visited Public Land Mobile Network |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |

### Definitions

For the purposes of the present document, the terms and definitions given in 3GPP TR 21.905 [1] and the following apply. A term defined in the present document takes precedence over the definition of the same term, if any, in 3GPP TR 21.905 [1].

### CITATION LIST

### Non Patent Literature

[1] 3GPP TR 21.905: “Vocabulary for 3GPP Specifications”. V17.1.0 (2021-12)
[2] SP-211068: https://www.3gpp.org/ftp/tsg_sa/TSG_SA/TSGS_93E_Electronic_2021_09/Docs/S P-211068.zip
[3] 3GPP TS 23.501: “System architecture for the 5G System (5GS)”. V17.5.0 (2022-06)
[4] 3GPP TS 23.502: “Procedures for the 5G System (5GS)”. V17.5.0 (2022-06)
[5] 3GPP TS 23.503: “Policy and charging control framework for the 5G System (5GS) Stage 2”. V17.5.0 (2022-06)
[6] 3GPP TS 22.011: “Service accessibility”. V18.3.0 (2022-06)
[7] 3GPP TS 24.501: “Non-Access-Stratum (NAS) protocol for 5G System (5GS) Stage 3”. V17.7.1 (2022-06)
[8] 3GPP TS 23.122: “Non-Access-Stratum (NAS) functions related to Mobile Station (MS) in idle mode”. V17.7.1 (2022-06)

### <General>

Those skilled in the art will appreciate that elements in the Figs are illustrated for simplicity and may not have necessarily been drawn to scale. Furthermore, in terms of the construction of the device, one or more components of the device may have been represented in the Figs by conventional symbols, and the Figs may show only those specific details that are pertinent to understanding the Aspects of the present disclosure so as not to obscure the Figs with details that will be readily apparent to those skilled in the art having the benefit of the description herein.

For the purpose of promoting an understanding of the principles of the disclosure, reference will now be made to the Aspect illustrated in the Figs and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

### <First Aspect>

This aspect discloses a mechanism that enables to transfer an information for the Operator controlled signal threshold per access technology securely from the home operator to the USIM 35 that is installed in an UE 3 while the UE 3 roams to a VPLMN.

### First Example of the First Aspect

When an information for the Operator controlled signal threshold per access technology has not been provisioned to the UE 3, the UE 3 initiates the Registration procedure to fetch the information from the HPLMN using the 5GS.

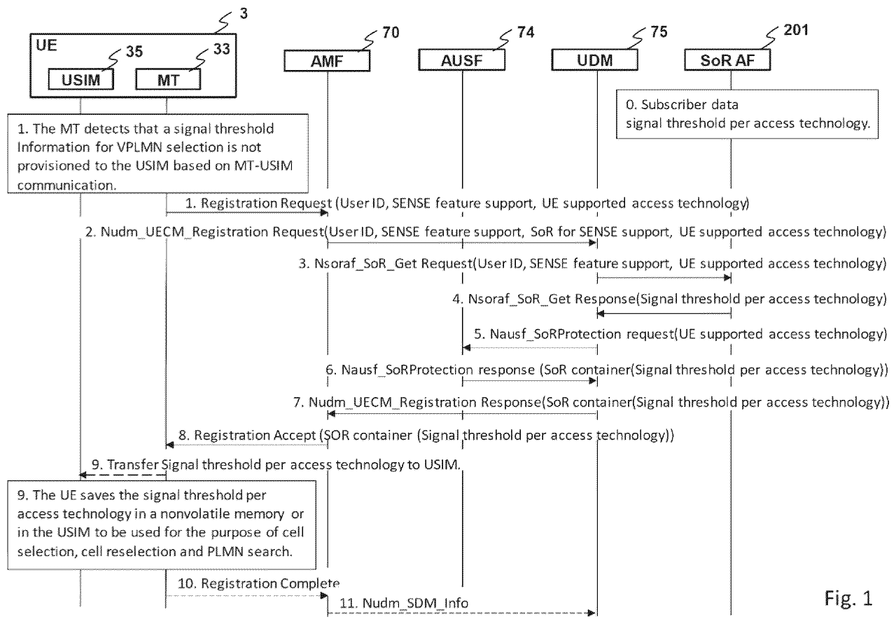

FIG. 1 is a Registration procedure for fetching the Operator controlled signal threshold per access technology from home network.

The detailed processes of the First example of the First Aspect are described below, with reference to FIG. 1. Note that the MT 33 in the FIG. 1 indicates the mobile terminal part of the UE 3. The MT 33 may be the UE 3 excluding USIM 35.

Step 0. The SoR AF 201 stores an information for the signal threshold per access technology in the subscriber data.

The SoR AF 201 may store a signal threshold for NB-IoT, GERAN EC-GSM-IoT, Category M1 of E-UTRA, Category M2 of E-UTRA and other access technology. The SoR AF 201 may store a signal threshold for WiFi as non-3GPP access as well.

Step 1. When the MT 33 in the UE 3 detects that an operator controlled signal threshold per access technology Information is not provisioned to the USIM 35 or in a non-volatile memory in the UE 3, the UE 3 sends a Registration Request message, to an AMF 70, including User ID, SENSE feature support and UE supporting access technology. The SENSE (Signal Level Enhanced Network Selection) feature support parameter, or any other notation for a parameter with purpose to indicate the UE supports the operator controlled signal threshold per access technology feature, indicates that the UE 3 supports the SENSE feature.

The UE supporting access technology parameter, transmitted from the UE, indicates one or more access technologies that the UE 3 supports.

The UE supporting access technology may include an indication to support NB-IoT, GERAN EC-GSM-IoT, Category M1 of E-UTRA, Category M2 of E-UTRA and other access technology (e.g. NR).

In one example when a UE is configured from manual PLMN mode selection to automatic PLMN mode selection and finds that the operator controlled signal threshold per access technology is not configured then it will also initiate registration procedure as defined in this step.

The SENSE feature support can be another name. For example, SENSE information query, SENSE request or any other name for indicating that the UE3 requests to have a SENSE related information from the AMF70.

The UE supporting access technology can be another name. For example, access technology or any other name for indicating that one or more access technologies supported by UE3.

Step 2. When the AMF 70 receives the Registration Request message, the AMF 70 sends the Nudm_UECM_Registration Request message, to the UDM 75, including the User ID, the SENSE feature support, UE supporting access technology and SoR for SENSE support. The SENSE feature support parameter and the UE supporting access technology that are received in the step 1. If the AMF 70 does not receive the SENSE feature support indication from the UE 3, the AMF 70 recognizes that the UE 3 does not support the SENSE feature and the AMF 70 does not include SENSE feature support nor UE supporting access technology in the Nudm_UECM_Registration Request message. The SoR for SENSE support indicates that the AMF 70 has a capability to transfer a SENSE related information to the UE 3 using the SoR mechanism.

The SENSE feature support can be another name. For example, SENSE information query, SENSE request or any other name for indicating that the AMF70 requests to have a SENSE related information from the UDM75.

The UE supporting access technology can be another name. For example, access technology or any other name for indicating that one or more access technologies supported by UE3.

The SoR for SENSE can be another name indicating that the AMF 70 has a capability to transfer a SENSE related information to the UE 3 using the SoR mechanism.

Step 3. When the UDM 75 receives the Nudm_UECM_Registration Request message including the User ID, the SENSE feature support and the UE supporting access technology and SoR for SENSE support, the UDM 75 sends the Nsoraf_SoR_Get Request message (or a new message or any existing message) including the User ID and the SENSE feature support indication and the UE supporting access technology that are received in the step 2. The SENSE feature support can be another name. For example, SENSE information query, SENSE request or any other name for indicating that the UDM 75 requests to have a SENSE related information from the SOR AF 201.

If the UDM 75 does not receive the SENSE feature support indication from the AMF 70, the UDM 75 assumes that the UE 3 does not support the SENSE feature and the UDM 75 does not send the Nsoraf_SoR_Get Request message to the SoR-AF 201. If the UDM 75 does not receive the SoR for SENSE support from the AMF 70, the UDM 75 assumes that the AMF 70 does not support the SENSE feature and the UDM 75 does not sends the Nsoraf_SoR_Get Request message to the SoR-AF 201.

In one example, the SENSE feature support can be interpreted by the UDM 70 that the AMF supports the SOR feature. In this case, the UDM 70 sends the Nsoraf_SoR_Get Request message (a new message or existing message) to the SoR-AF 201 even the UDM 70 does not receive the SoR for SENSE support from the AMF 70.

The UE supporting access technology can be another name. For example, access technology or any other name for indicating that one or more access technologies supported by UE3.

Step 4. Upon receiving the Nsoraf_SoR_Get Request message including the User ID (e.g. SUPI or GPSI) and the SENSE feature support and the UE supporting access technology, the SoR AF 201 finds the information for signal threshold per access technology from the subscriber data record (e.g. memory) for a subscriber identified by the User ID. Then the SoR-AF 201 sends the Nsoraf_SoR_Get Response message (e.g. a new message or existing message) to the UDM 75 including the information for signal threshold per access technology for the UE 3.

Step 5. When the UDM 75 receives the Nsoraf_SoR_Get Response message, from the SoR-AF 201, including the information for signal threshold per access technology for the UE 3, the UDM 75 sends the Nausf_SoRProtection request message (a new message or existing message), to the AUSF 74, including the information for signal threshold per access technology in order to secure this information. The UDM 75 may include ACK indication in the Nausf_SoRProtection request message in order to receive an indication from the UE 3 if the SoR container has been successfully delivered to the UE 3.

Step 6. When the AUSF 74 receives the ausf_SoRProtection request message, from the UDM 75, including the information for signal threshold per access technology, the AUSF 74 encrypts this information and the AUSF 74 sends the Nausf_SoRProtection response message, to the UDM 75, including the SoR container which contains the encrypted information for signal threshold per access technology.

Step 7. When the UDM 75 receives the Nausf_SoRProtection response message, from the AUSF 74, including the SoR container which contains the encrypted information for signal threshold per access technology, the UDM 75 sends Nudm_UECM_Registration Response message to the AMF 70 including the SoR container which contains the encrypted information for signal threshold per access technology. The UDM 75 may include ACK indication in the Nudm_UECM_Registration Response message.

The SOR container is defined as below.

| | | | | | | | |
|---|---|---|---|---|---|---|---|
| 8 | 7 | 6 | 5 | 4 | 3 | 2 | 1 |

| SOR transparent container IEI | octet 1 |
|---|---|
| Length of SOR container contents | octet 2 |
| | octet 3 |
| SOR header | octet 4 |
| SOR-MAC-I_{AUSF} | octet 5-20 |
| Counter_{SignalThreshold} | octet 21-22 |
| Secured packet | octet 23*-n* |

The secured packet is defined as

access technology identifier 1
Signal quality or Signal strength
. . . Singal threshold
. . .
access technology identifier 2
Signal quality or Signal strength
. . . Singal threshold

Step 8. When the AMF 70 receives the Nudm_UECM_Registration Response message including the SoR container which contains the encrypted information for signal threshold per access technology, the AMF 70 sends the Registration Accept message to the UE 3 including the SoR container which contains the encrypted information for signal threshold per access technology. The AMF 70 may include ACK indication in the Registration Accept message.

Step 9. When the MT 33 in the UE 3 receives the Registration Accept message from the AMF 70 including the SoR transparent container which contains the encrypted information for signal threshold per access technology, the MT 33 decrypts the SoR transparent container to get the information for signal threshold per access technology. The MT 33 either sends the information to the USIM 35 or stores the information in a nonvolatile memory of the UE 3.

After the MT 33 decrypted the information for signal threshold per access technology from the SoR transparent container, the NAS layer of the UE 3 informs the information for signal threshold per access technology to the AS layer of the UE 3. For example, the information for signal threshold per access technology may consist of the list of the measured signal strength (e.g. RSRP), the measured signal quality (e.g. RSRQ) and the measured signal to noise interference (e.g. SINR) per access technology.

In case the MT 33 receives invalid value for an access technology, the UE 3 ignores the value and doesn't store the value in USIM 35 and doesn't apply the threshold.

In one example the UDM 75 sends a fixed value e.g. 0 for each access technology to disable the cell selection or reselection procedure based on the signal threshold per access technology. when the UE 3 receives the value the doesn't apply the cell selection or reselection procedure for the access technology.

Step 10. In case that the UE 3 is requested to acknowledge for successful delivery of the information for signal threshold per access technology, the UE 3 sends the Registration Complete message to the AMF 70.

Step 11. When the AMF 70 receives the Registration Complete message from the UE 3 and the AMF 70 was requested by the UDM 75 to acknowledge the successful delivery of the information for signal threshold per access technology to the UE 3, the AMF 70 sends the Nudm_SDM_Info message to the UDM 75 so that the UDM 75 can recognize the successful delivery of the information for signal threshold per access technology to the UE 3.

Operator controlled signal threshold per access technology can be expressed by another terminologies, for example signal threshold per access technology, signal quality threshold per access technology, threshold per access technology and etc in this disclosure.

User Identity can be expressed with User ID or UE ID in this disclosure.

### Variant 1 of First Example of the First Aspect

In one example, the SoR AM 201 can be included in the UDM 75. In this case, steps 3 and 4 are executed internally in the UDM 75.

### Variant 2 of First Example of the First Aspect

In one example, the UE 3 scans the available PLMN at the location and sends the list of signal strength or signal quality or both (e,g. RSRP (Reference Signal Received Power) and RSRQ (Reference Signal Received Quality) RSSI, in EPS) of the strongest cell of each PLMN available at the location in the registration request message. The AMF 70 sends the list of signal strength or signal quality or both to the UDM 75 in step 2. The UDM 75 sends the received list of signal strength or signal quality or both to the SoR-AF 201. SoR-AF 201 determines the signal strength for each access technology based on the received list of signal strength or signal quality or both.

In one example the List of signal strength or Signal quality is integrity protected or ciphered and sends to the UDM 75 in a transparent container.

### Variant 3 of First Example of the First Aspect

In another example, the operator controlled signal threshold per access technology information may be configured in the AMF 70 directly or via the OAM based on the operator policy. Then, during the UE 3 registration with the home PLMN, the operator controlled signal threshold per access technology information can be delivered by the AMF 70 to the UE 3 as per steps 8 and 9 in FIG. 1. Alternatively, the configured operator controlled signal threshold per access technology information in the AMF 70 can be delivered to the UE 3 via the UE Configuration Update message at any time during the UE 3 connection with the home PLMN or when the UE 3 is in idle mode via paging the UE 3 first.

### Variant 4 of First Example of the First Aspect

In another example, the operator controlled signal threshold per access technology information may be defined as a new rule for triggering cell selection/reselection or PLMN selection/reselection by the UE 3 as part of the URSP rules for UE 3 in the PCF and provided to the UE 3 within the URSP provision within the UE Policy information via the UE Configuration Update procedure as per 3GPP TS 23.502 [4] and 3GPP TS 23.503 [5].

### Variant 5 of First Example of the First Aspect

In another example, the operator controlled signal threshold per access technology information may be provided to the UE 3 by the AMF 70 via OTA (Over The Air) DM (Device management).

In another example, the UDM 75 can send the operator controlled signal threshold per access technology information in any existing or a new message defined between UDM 75 and the AMF 70. When the AMF 70 receives the operator controlled signal threshold per access technology information, the AMF 70 sends the received operator controlled signal threshold per access technology information to the UE 3 in an existing or a new NAS message. On receiving the operator controlled signal threshold per access technology information by the UE 3, the UE 3 sends an existing NAS message to the AMF indicating the reception of the operator controlled signal threshold per access technology information. The AMF 70, on reception of the NAS message from the UE 3, sends a message to the UDM 75 indicating reception of the operator controlled signal threshold per access technology information at the UE 3. This method of transmission of the operator controlled signal threshold per access technology information can be used when the UE 3 is registers in HPLMN or Equivalent HPLMN.

### Variant 6 of First Example of the First Aspect

In another example, the operator controlled signal threshold per access technology may be defined by the Service provider (for example when the mobile terminals belong to a third part service provider contracted with the signal threshold controlling PLMN). In this case the operator controlled signal threshold per access technology information is provided to the UDM 75 of the 3GPP network by the Service provider via the NEF entity in of the 3GPP network. Along with the provision of operator controlled signal threshold per access technology, the Service provider may provide extra information related to validity of the provided threshold or their applicability per UE or per group of UEs and the Service provider can update the operator controlled signal threshold per access technology and the conditions for their applicability at any time.

### Variant 7 of First Example of the First Aspect

In one example, the AS layer of the UE 3 provides the operator controlled signal threshold per access technology to the NG-RAN in an existing or a new RRC message. When the NG-RAN receives the operator controlled signal threshold per access technology from the AS layer of the UE 3, the NG RAN stores it and selects a target cell in the handover procedure when the signal strength of the target cell is equal to or greater than the operator controlled signal threshold per access technology.

### Variant 8 of First Example of the First Aspect

In one example, the AMF 70 provides the operator controlled signal threshold per access technology to the NG-RAN in an existing or a new NGAP message. When the NG-RAN receives the operator controlled signal threshold per access technology, the NG RAN stores it and selects a target cell in the handover procedure when the signal strength of the target cell is equal to or greater than the operator controlled signal threshold per access technology.

### Variant 9 of First Example of the First Aspect

The UE 3, at any time e, g. during power on procedure or during any NAS procedure, sends a list of the signal strength per access technology type that the UE 3 can receives and/or a list of the signal strength per PLMN that the UE 3 can receives and/or a list of the signal strength for all of best cell of each access technology available for each available PLMN that the UE 3 can receives and current UE location to the UDM 75 via AMF 70 transparently and security protected. For example, the UE 3 sends the list of signal strength by the Registration request message or registration complete message or in any NAS message to the AMF 70. Then the AMF 70 sends the received list of signal strength to the UDM 75 in an existing or a new message that are defined between the AMF 70 and the UDM 75. Upon reception of the list of signal strength, the UDM 75 may decide to update the operator controlled signal threshold per access technology based on the received value of signal strength in the list and the received current UE location.

For example, if a received signal strength for a particular access technology at the location of the UE 3 is far below from the operator controlled signal threshold for the access technology in the UDM 75, then the UDM 75 decreases the threshold value for the operator controlled signal threshold for the access technology and updates newly defined threshold value in the UE 3 using the mechanism as disclosed by the first aspect.

### Variant 10 of First Example of the First Aspect

The UE 3, at any time e,g. during power on procedure or during any NAS procedure, sends current value of the stored threshold to the UDM via AMF. The current value of the stored threshold may be sent to the UDM 75 via AMF 70 transparently and security protected. If the UE 3 has value of the stored threshold stored in neither USIM 35 nor ME memory of the UE 3, then the UE 3 indicates to the UDM 75 that the UE 3 has no current value for the operator specific threshold.

The UDM 75 may decide to send the operator controlled signal threshold per access technology to the UE 3 based on the received current value of the stored threshold in the UE 3 or indication from the UE 3.

For example, if a received current value of the stored threshold in the UE 3 is out of date, then the UDM 75 updates the UE 3 with the latest operator controlled signal threshold for the access technology using the mechanism as disclosed by the first aspect.

### Variant 11 of First example of the First Aspect

In steps 2 to 7, the AMF 70 and the UDM 75 may use an existing message or a new message between the AMF 70 and UDM 75.

### Second Aspect

This aspect discloses a mechanism that how the UE 3 obtains the information for the Operator controlled signal threshold per access technology over the 5GS and how the UE 3 uses this information for NB-IoT, GERAN EC-GSM-IoT and Category M1 or M2 of E-UTRA.

### First Example of the Second Aspect

A First example of the Second Aspect discloses a method how the UE 3 obtains the information for the Operator controlled signal threshold per access technology over the 5GS and how the UE 3 uses this information for NB-IoT, GERAN EC-GSM-IoT and Category M1 or M2 of E-UTRA.

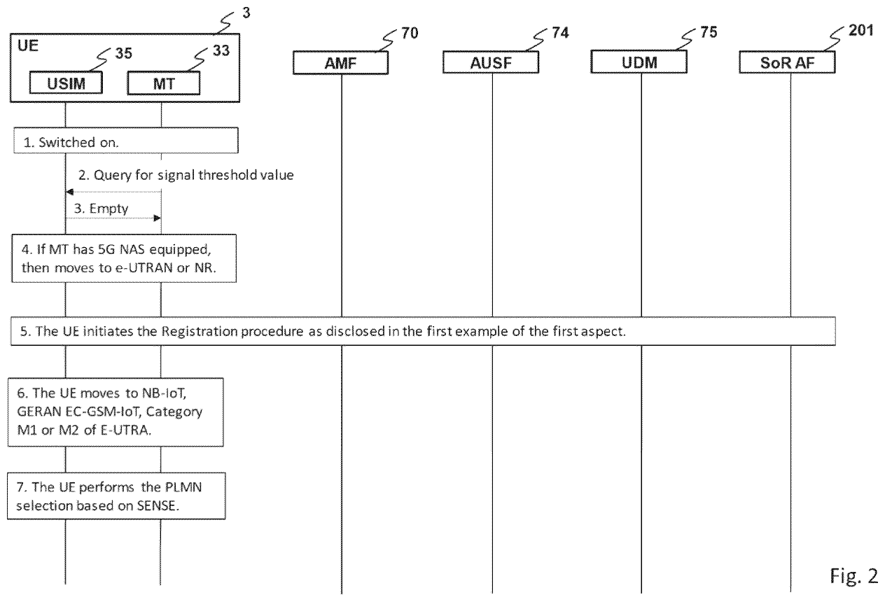

FIG. 2 is a UE behavior for SENSE feature. The detailed processes of the first example of the Second Aspect are described below, with reference to FIG. 2. Note that the MT 33 in the FIG. 2 indicates the mobile terminal part of the UE 3. The MT 33 may be the UE 3 excluding USIM 35.

Step 1. The UE 3 is switched on. Another use cases in step 1 could be that new SIM 35 is inserted to the UE 3, the UE 3 is initialized by the user or any other cases for resetting the UE 3.

Another use cases in step 1 could be recovery from lack of coverage, periodic network selection attempts, and steering of roaming.

Step 2. The MT 33 makes a query to the USIM 35 whether the USIM 35 holds the information for signal threshold per access technology. The MT 33 may indicate an access technology in the query message in order to obtain a signal threshold for that access technology. The access technology includes NB-IoT, GERAN EC-GSM-IoT, Category M1 of E-UTRA, Category M2 of E-UTRA and other access technology. The access technology includes WiFi as non-3GPP access as well. In case that the information for signal threshold per access technology is stored in a nonvolatile memory in the UE 3, the MT 33 does not make a query to the USIM 35. The UE 3 refers to that memory and continues with the step 4.

Step 3. When the USIM 35 receives the query message in step 1, if the USIM 35 holds the information for signal threshold per access technology, the USIM 35 provides the information for signal threshold per access technology to the MT 33. Otherwise, the USIM 35 simply sends a negative message to MT 33 or provide empty information for the signal threshold per access technology.

Step 4. The following conditions are examined by the UE 3. If all conditions are met, then the UE 3 continues with step 5.
The UE 3 has a capability to handle the SENSE feature.
The UE 3 does not hold the information for signal threshold per access technology.
The UE 3 has a capability to access to 5GS. I.e., the UE 3 supports 5G NAS. The UE 3 has a capability to connect to NR or e-URAN or any other RAT (e.g. WLAN, Wi-Fi, BBF Access, Cable Access, optical access) that can connect to the 5GC.

Step 5. Based on the examination taken place in the step 4, the UE 3 initiates the Registration procedure as disclosed in the first example of the first aspect.

In one example, if cells supporting UTRAN or E-UTRAN or GERAN or NRs are present at the current location, the UE 3 shall choose a cell supporting 5GS even though the chosen cell is not the best cell available at the location or chosen cell doesn't belong to last registered PLMN or belongs to the PLMN which is not higher preferred PLMN available at the location and initiate registration procedure on the selected cell of the PLMN to register to the 5GS.

For example, suppose PLMN 1, PLMN 2 and PLMN 3 are stored in operator preferred PLMN list in highest to least priority order that i.e., PLMN1>PLMN 2>PLMN 3. At the current location E-UTRAN cell 1 belonging to the PLMN 1 is present which does not support connectivity to 5GS and cell 2 belonging to NG-RAN of PLMN 2 is present, then the UE 3 shall select cell 2 of PLMN 2 and initiates registration procedure on the cell 2 to PLMN 2.

Step 6. Upon a successful completion of the Registration procedure in step 5, the UE 3 moves GSM based GPRS, W-CDMA based GPRS or EPS to access with access technologies such as NB-IoT, GERAN EC-GSM-IoT and Category M1 or M2 of E-UTRA.

Step 7. The UE 3 initiates the PLMN selection based on the received information in step 5 for signal threshold for an access technology that the UE 3 currently tunes to.

Operator controlled signal threshold per access technology can be expressed by another terminologies, for example signal threshold per access technology, signal quality threshold per access technology, threshold per access technology and etc in this disclosure.

User Identity can be expressed with User ID or UE ID in this disclosure.

### Second Example of the Second Aspect

A Second example of the Second Aspect discloses a method how the UE 3 uses the signal threshold for the PLMN selection. This example can be used at the step 7 of the First example of the Second Aspect.

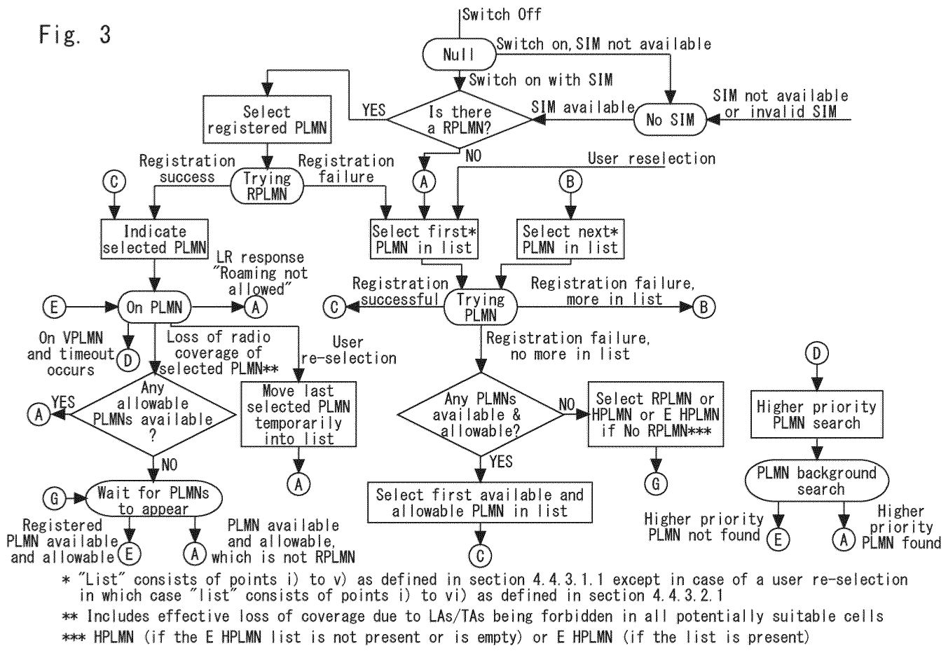

The FIG. 3 illustrates the existing PLMN selection diagram in 3GPP TS 23.122 [8]. This example discloses the following updates to the processes in the FIG. 3.

### <First Disclosure for Updating the Process “Select Registered PLMN”>

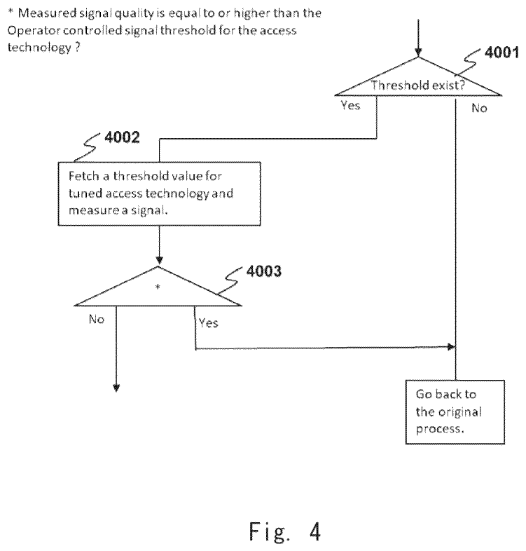

FIG. 4 is a Signaling measurement based on the signal threshold. For the process “Select registered PLMN” at the upper left of the FIG. 3, this process is replaced with the process as shown in the FIG. 4 with the following process flow.

Process 4001. The UE 3 checks whether the UE 3 holds a signal threshold information for the access technology that the UE 3 tunes to. If the UE 3 holds the signal threshold information for the access technology, the UE 3 does not look first for the last registered PLMN availability in its location after switch on or after returning from no service state as per the legacy behaviour in FIG. 3. Instead, the UE 3 goes to the process 4002. Otherwise, the UE 3 goes back to follow the original procedure in FIG. 3.

Process 4002. The UE 3 fetches the operator controlled signal threshold per access technology information stored in the USIM 35 in the UE 3 or in the non-volatile memory in the UE 3 for the UE's radio access (i.e. the radio access the UE is tuned on) and the UE 3 fetches the signal strength or signal quality or signal to noise interference measurements (e.g. RSRP (Reference Signal Received Power) or RSRQ (Reference Signal Received Quality) or SINR (Signal to Interference plus Noise Ratio)) for all the cells of the UE's Radio Access in the UE location.

Process 4003. If the measured signal strength (e.g. RSRP) or the measured signal quality (e.g. RSRQ) or the measured signal to noise interference (e.g. SINR) of one of the available cells from any PLMN that the UE 3 is allowed to select in the UE location on the same radio access is equal to or higher than the Operator controlled signal threshold value for the access technology, the UE 3 shall select the cell of that PLMN (i.e. the UE 3 shall select a cell with highest signal strength or highest signal quality or highest signal to noise ratio or a combination of the three belonging to any of the PLMNs the UE 3 is allowed to select) and the UE 3 shall continue with the PLMN selection process from point C of the PLMN selection diagram in FIG. 3. Otherwise, the UE 3 shall go back and start from the beginning of the PLMN selection diagram in FIG. 3, i.e PLMN selection with no consideration for the operator controlled signal threshold per access technology information.

### <Second Disclosure for Updating the Process “Select PLMN”>

For the process right after the connection circle A and the process right after the connection circle B in the FIG. 3, they are replaced with the process as shown in the FIG. 4 with the following process flow.

Process 4001. The UE 3 checks whether the UE 3 holds a signal threshold information for the access technology that the UE 3 tunes to. If the UE 3 holds the signal threshold information for the access technology, go to the process 4302. Otherwise, go back to the original process.

Process 4002. The UE 3 fetches a threshold value for tuned access technology and measure a signal.

Process 4003. If the measured signal quality is equal to or higher than the Operator controlled signal threshold value for the access technology, go back to the original process. Otherwise, skip the original process and go to next process as shown as “Trying PLMN”. In this case, the “Trying PLMN” process does not initiate the Registration procedure. The “Tying PLMN” process just judges whether there are more PLMNs in the list or not. I.E, it goes to either the line in the middle under the “Trying PLMN” process or the right line under the “Trying PLMN” process.

### <Third Disclosure for Updating the Process “Select First Available and Allowable PLMN in List”>

For the process “Select first available and allowable PLMN in list” located lower part in the FIG. 3, it is replaced with the process as shown in the FIG. 4 with the following process flow.

Process 4001. The UE 3 checks whether the UE 3 holds a signal threshold information for the access technology that the UE 3 tunes to. If the UE 3 holds the signal threshold information for the access technology, go to the process 3002.

Otherwise, go back to the original process.

Process 4002. The UE 3 fetches a threshold value for tuned access technology and measure a signal.

Process 4003. If the measured signal quality is equal to or higher than the Operator controlled signal threshold value for the access technology, go back to the original process. Otherwise, go to the line in the middle under the “On PLMN” process.

### Variant 1 of Second Example of the Second Aspect

In another example, the operator controlled signal threshold per access technology information may be considered as an offset value, i.e. the UE 3 shall select a cell from another PLMN only of the difference in the signal strength (e.g. RSRP) or the difference in the signal quality (e.g. RSRQ) or the difference in the signal to noise ratio between the current cell of the home PLMN and the cell from other PLMN is equal or higher than the operator controlled signal threshold per access technology in favor of the cell from the other PLMN. In this case the UE 3 shall select the cell from other PLMN and register with the other PLMN.

### Third Example of the Second Aspect

A Third example of the Second Aspect discloses a method how the UE 3 judges the measured signal using the signal threshold for the PLMN selection. This example can be used at the step 4003 of the Second example of the Second Aspect.

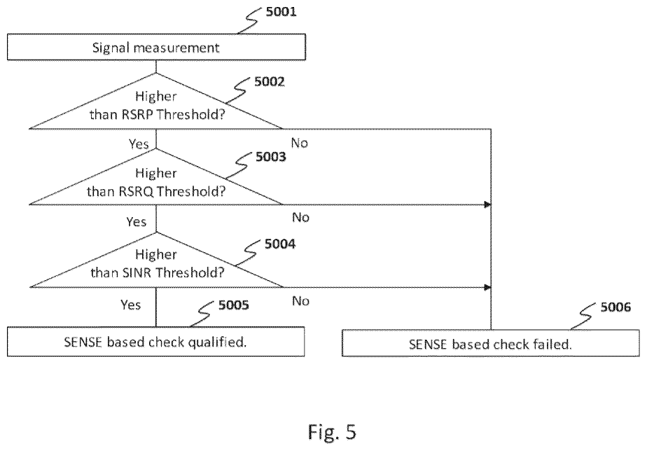

The FIG. 5 illustrates the flow how the UE 3 judges the measured signal.

Process 5001. The UE 3 measures a signal over an access technology.

Process 5002. The UE 3 compares the received signal level with the RSRP as indicated by the Operator controlled signal threshold value for the access technology. If the received signal level is equal to or higher than the Operator controlled signal threshold, go to the process 5003. Otherwise, go to the Process 5006 and concludes that the SENSE based signalling check has failed.

Process 5003. The UE 3 compares the received signal quality with the RSRQ as indicated by the Operator controlled signal threshold value for the access technology. If the measured signal quality is equal to or higher than the Operator controlled signal threshold, go to the process 5004. Otherwise, go to the Process 5006 and concludes that the SENSE based signalling check has failed.

Process 5004. The UE 3 compares the received Signal to Interference plus Noise Ratio with the SINR as indicated by the Operator controlled signal threshold value for the access technology. If the measured Signal to Interference plus Noise Ratio is equal to or higher than the Operator controlled signal threshold, go to the process 5005 and concludes that the SENSE based signalling check has been passed and quailed. Otherwise, go to the Process 5006 and concludes that the SENSE based signalling check has failed.

### Variant 1 of Third Example of the Second Aspect

In another example, operator controlled signal threshold per access technology may be applicable for difference in the signal strength between the cells only or for difference in the signal quality between the cells only or for difference in the signal to noise ratio between the cells only or for any combination between these three operator controlled signal thresholds per access technology. Depending on the operator controlled signal threshold per access technology applicability, the UE 3 may compare the home PLMN cell with cells from another PLMN only for difference in the signal strength, or difference in the signal quality or for difference in signal to noise ratio or for any other combination between these three types of threshold or for all the three as per FIG. 5.

### <System Overview>

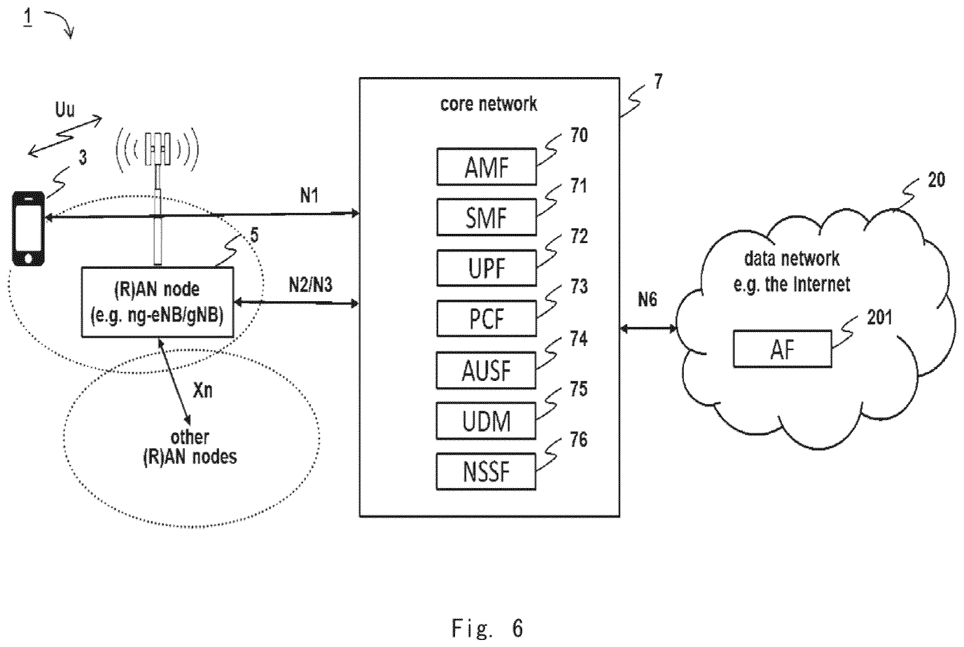

FIG. 6 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Slice Selection Function (NSSF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPV4, IPV6, IPv4v6, Ethernet or unstructured data type. The data network may include an AAA 201.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

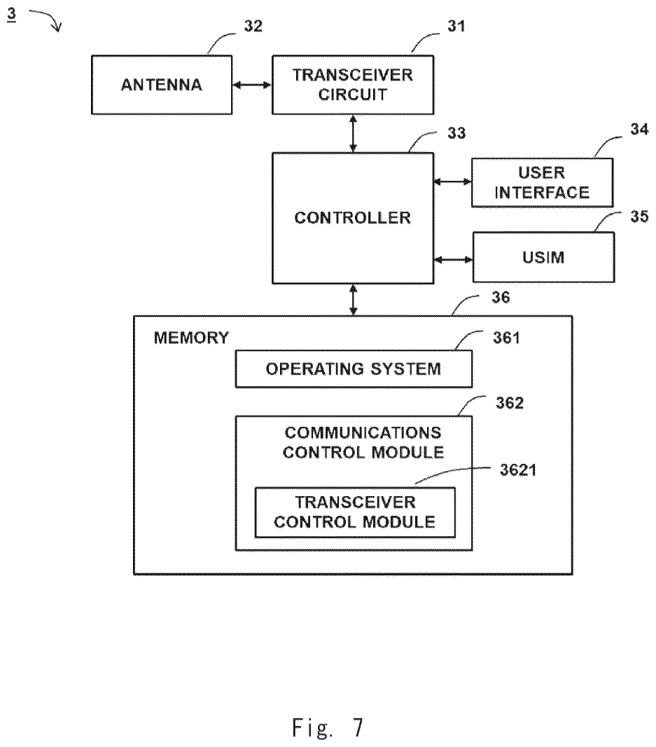

FIG. 7 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Fig, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

the UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### < (R)AN Node>

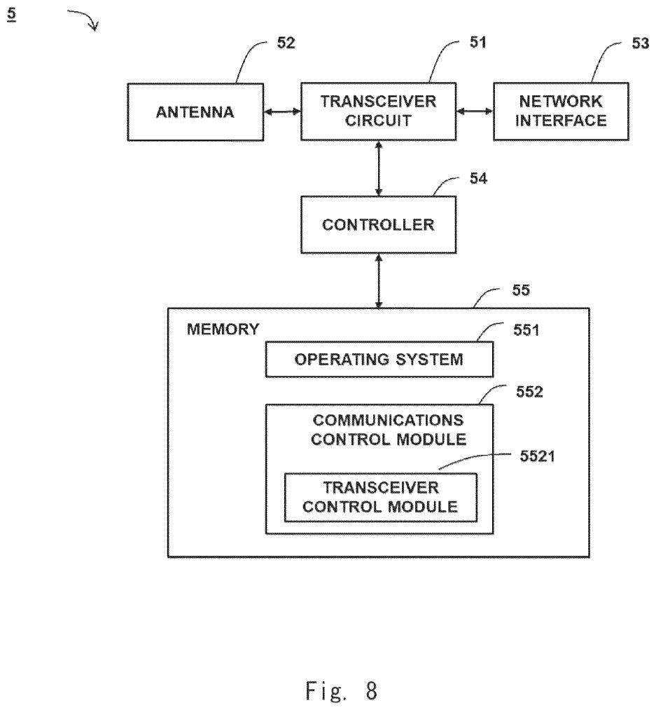

FIG. 8 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

The Current RAN 501 and the Candidate RAN 502 may have same components to the (R)AN node 5. The (R)AN node 5 may be expressed as a RAN node, RAN, (R)AN etc.,

### <System Overview of (R)AN Node 5 Based on O-RAN Architecture>

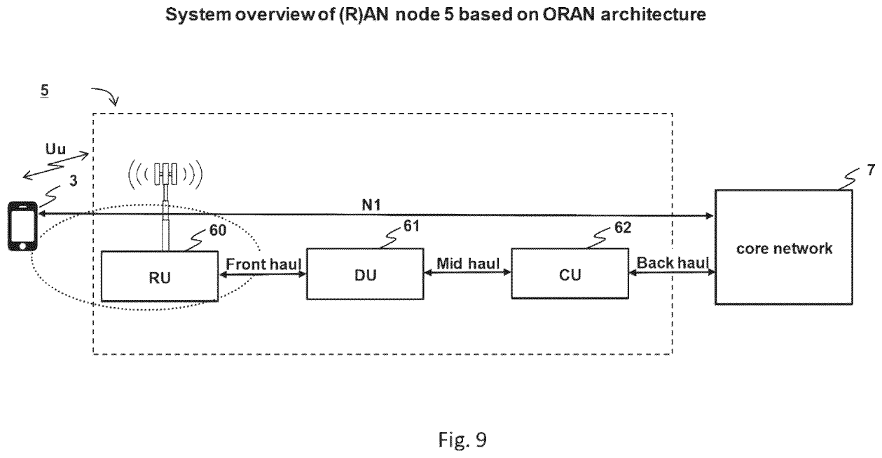

FIG. 9 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

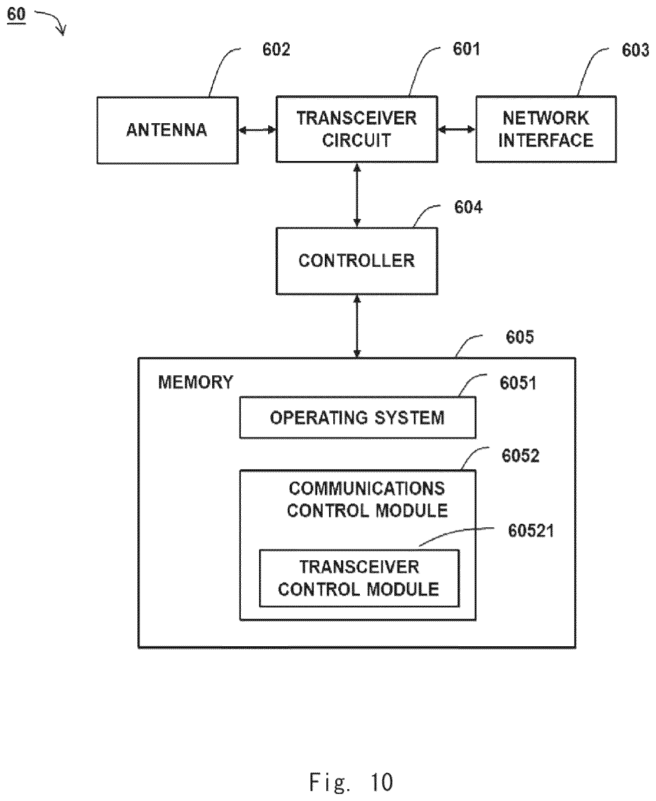

FIG. 10 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and

DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN

### (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

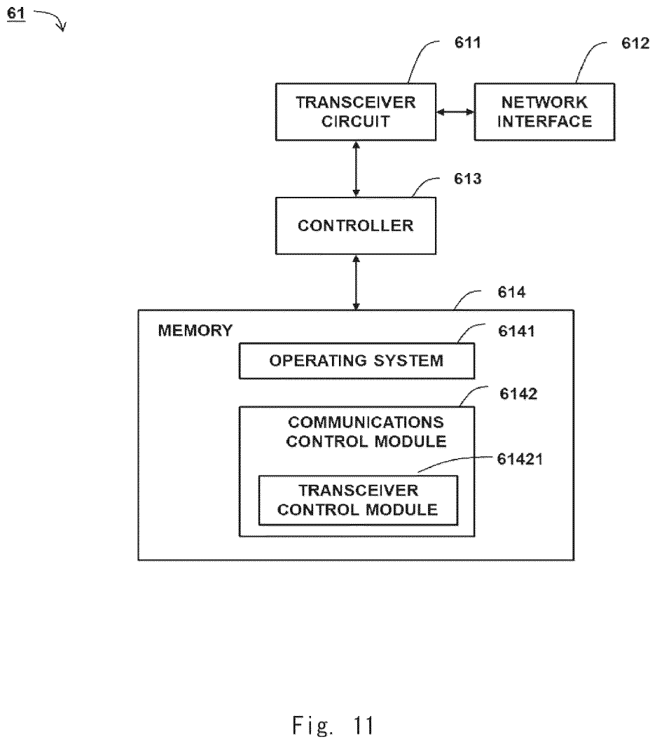

FIG. 11 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

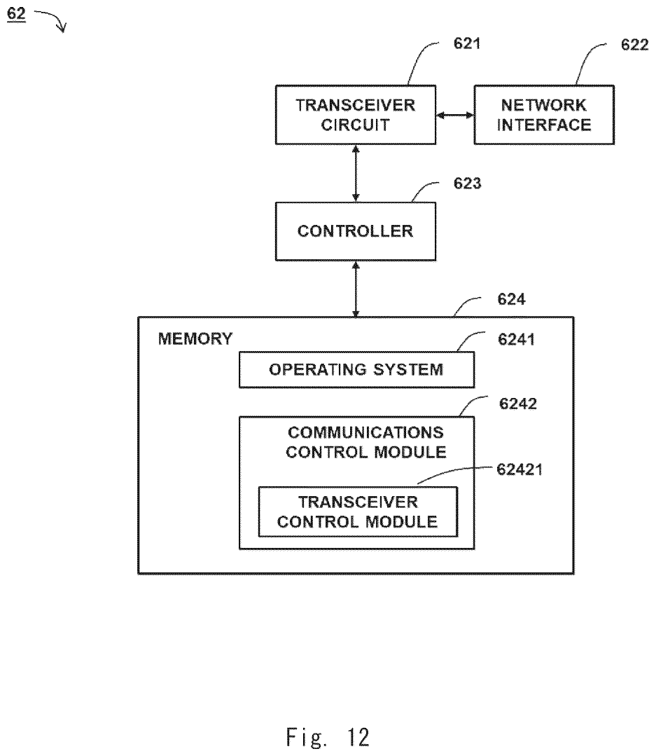

FIG. 12 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

<AMF>

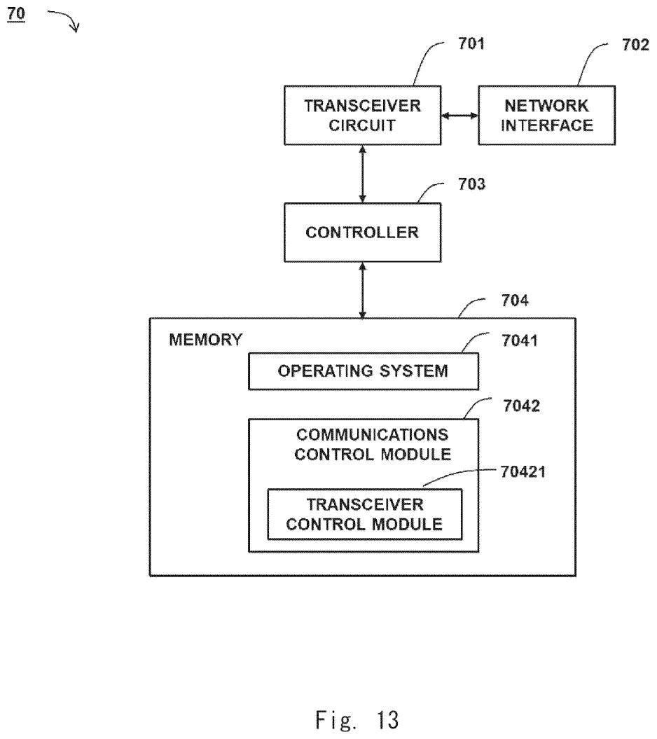

FIG. 13 is a block diagram illustrating the main components of the AMF 70. As shown, the apparatus includes a transceiver circuit 701 which is operable to transmit signals to and to receive signals from other nodes (including the UE 3, the NSSF 76) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN). An AMF 7001 and an AMF 7002 may have same components to the AMF 70.

### <PCF>

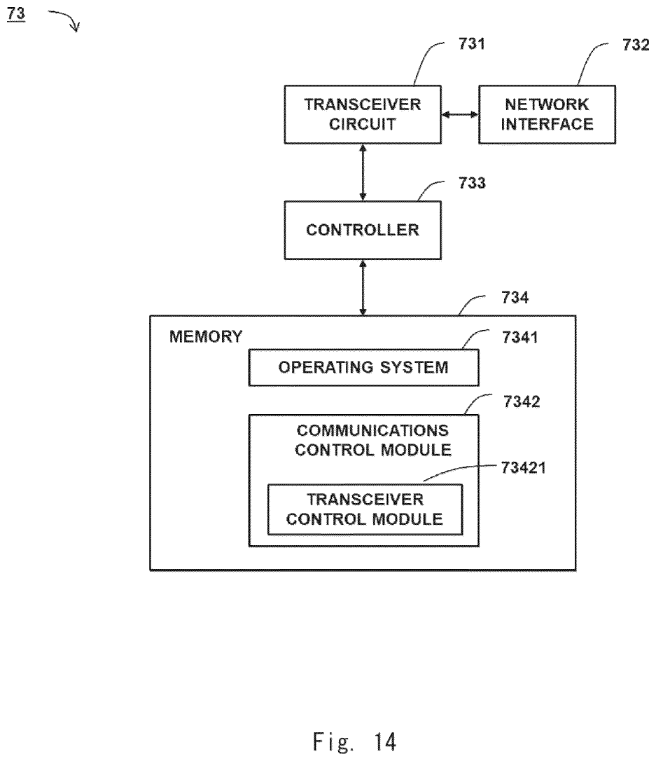

FIG. 14 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). A PCF 7301 and a PCF 7302 may have same components to the PCF 73.

### <AUSF>

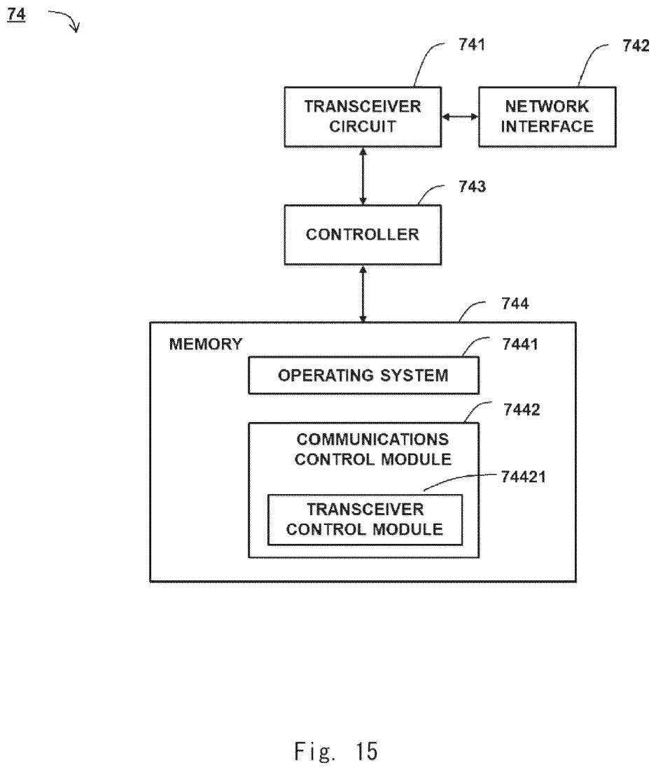

FIG. 15 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### <UDM>

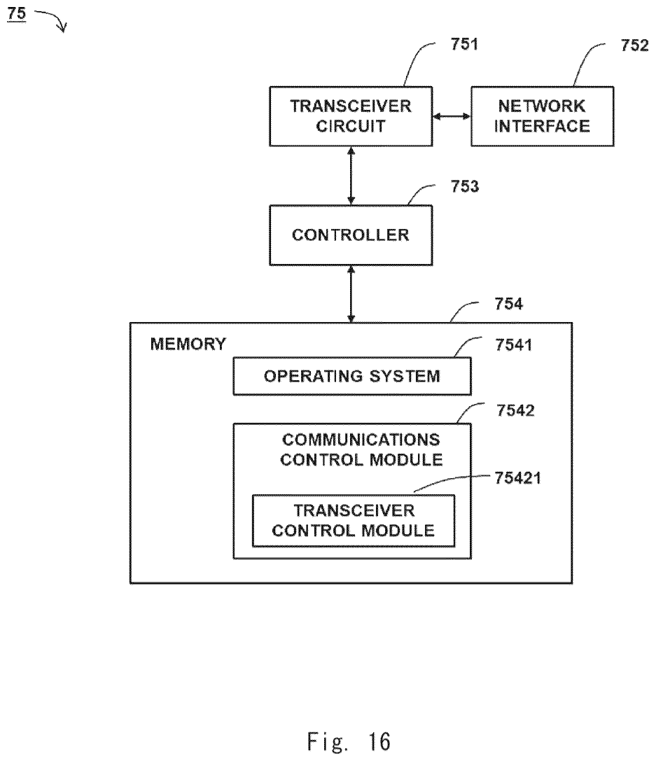

FIG. 16 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

<NSSF>

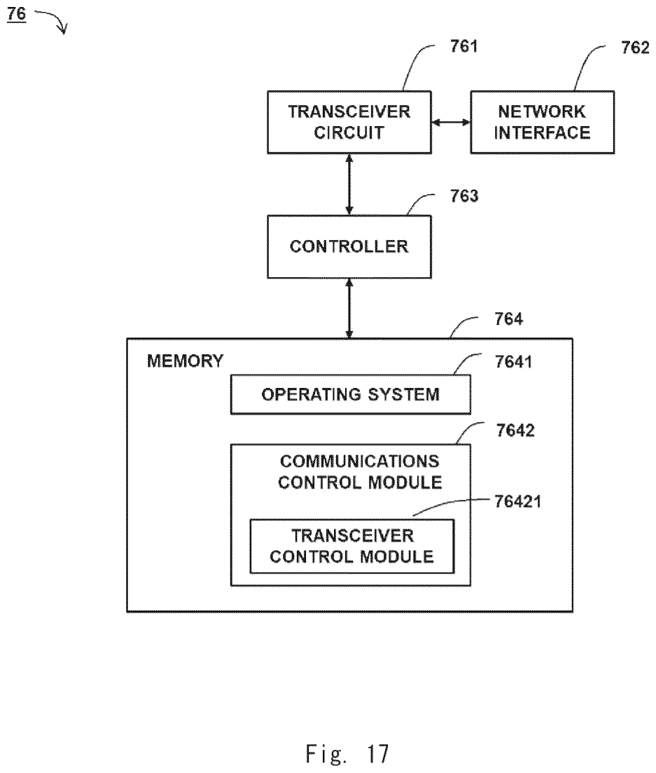

FIG. 17 is a block diagram illustrating the main components of the NSSF 76. As shown, the apparatus includes a transceiver circuit 761 which is operable to transmit signals to and to receive signals from other nodes (including the AMF 70) via a network interface 762. A controller 763 controls the operation of the NSSF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NSSF 76 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The NSSF 76 may support the Non-Public Network (NPN), The NPN may be a Stand-alone Non-Public Network (SNPN) or a Public Network Integrated NPN (PNI-NPN).

The whole or part of the example Aspects disclosed above can be described as, but not limited to, the following.

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

This application is based upon and claims the benefit of priority from Indian Patent Application number 202211051126, filed on Sep. 7, 2022, the disclosure of which is incorporated herein in its entirety by reference.

### <Supplementary Notes>

The whole or part of the example Aspects disclosed above can be described as, but not limited to, the following supplementary notes.

### (Supplementary Note 1)

A user equipment (UE) including a Mobile Termination (MT) and a User Services Identity Module (USIM), the UE comprising:
a transmitter configured to transmit, to an Access and Mobility Management Function (AMF), a Registration Request message, in a case where an Operator controlled signal threshold per access technology is not set on the USIM or not applied by the UE, and
a receiver configured to receive, from the AMF, a Registration Accept message including information indicating the Operator controlled signal threshold per access technology.

### (Supplementary Note 2)

The UE according to supplementary note 1, wherein
the Registration Request message includes a User ID, first information, and second information,
the first information indicating whether the UE supports Signal Level Enhanced Network Selection (SENSE) feature, and
the second information indicating the access technology supported by the UE.

### (Supplementary Note 3)

The UE according to supplementary note 2, wherein the access technology includes NB-IoT, GERAN EC-GSM-IoT, Category M1 of E-UTRA, Category M2 of E-UTRA, Wi-Fi, and New Radio (NR) technology.

### (Supplementary Note 4)

The UE according to supplementary note 1, wherein
the MT stores the information indicating the Operator controlled signal threshold per access technology, received from the AMF, in the USIM or in a nonvolatile memory of the UE.

### (Supplementary Note 5)

The UE according to supplementary note 1, wherein
a processor performs cell selection procedure, cell reselection procedure, and Public Land Mobile Network (PLMN) selection procedure by using the information indicating the Operator controlled signal threshold per access technology.

### (Supplementary Note 6)

An Access and Mobility Management Function (AMF) comprising:
a receiver configured to receive, from a user equipment (UE), a Registration Request message, and
a transmitter configured to transmit, to the UE, a Registration Accept message including information indicating a signal threshold per access technology, the information being received from a Unified Data Management (UDM).

### (Supplementary Note 7)

The AMF according to supplementary note 6, wherein
the receiver is configured to receive, from the UE, the Registration Request message, the Registration Request message including a UE-ID, first information, and second information,
the first information indicating whether the UE supports Signal Level Enhanced Network Selection (SENSE) feature,
the second information indicating access technology supported by the UE, the transmitter is configured to transmit, to the UDM, a first request message based on the first information and the second information,
the receiver is configured to receive, from the UDM, a first response message including information indicating an Operator controlled signal threshold per the access technology, and
the transmitter is configured to transmit, to the UE, the Registration Accept message including the information indicating the Operator controlled signal threshold per access technology.

### (Supplementary Note 8)

The AMF according to supplementary note 7, wherein
the first request message includes the first information, the second information, and third information if the first information indicates that the UE supports the SENSE feature, and
the first request message includes the third information if the first information indicates that the UE does not support the SENSE feature, wherein
the third information indicates whether the AMF has a capability to transfer information related to Signal Level Enhanced Network Selection (SENSE) feature to the UE by using the Steering of Roaming (SOR) mechanism.

### (Supplementary Note 9)

The AMF according to supplementary note 7, wherein
the first request message includes Nudm_UECM_Registration Request message, and
the first response message includes Nudm_UECM_Registration Response message.

### (Supplementary Note 10)

A Unified Data Management (UDM) comprising:
a receiver configured to receive, from an Access and Mobility Management Function (AMF), first request message,
a transmitter configured to transmit, to a Steering Of Roaming Application Function (SoR-AF), second request message,
the receiver configured to receive, from the SoR-AF, second response message including information indicating an Operator controlled signal threshold per access technology, and
the transmitter configured to transmit, to the AMF, first response message including the information indicating the Operator controlled signal threshold per access technology.

### (Supplementary Note 11)

The UDM according to supplementary note 10, wherein
a transmitter configured to transmit, to the AMF, the first response message including the information indicating the Operator controlled signal threshold per access technology in response to the first request message received from the AMF.

### (Supplementary Note 12)

The UDM according to supplementary note 10, wherein
the first request message includes Nudm_UECM_Registration Request message,
the first response message includes Nudm_UECM_Registration Response message,
the second request message includes Nsoraf_SoR_Get Request message, and
the second response message includes Nsoraf_SoR_Get Response message.

### (Supplementary Note 13)

The UDM according to supplementary note 10, wherein
the transmitter is configured to transmit, to Authentication Server Function (AUSF), third request message including the information indicating the Operator controlled signal threshold per access technology to secure the information indicating the Operator controlled signal threshold per access technology, and
the receiver is configured to receive, from the AUSF, third response message including secured information indicating the Operator controlled signal threshold per access technology, the secured information being secured by the AUSF.

### (Supplementary Note 14)

A method in a user equipment (UE) including a Mobile Termination (MT) and a User Services Identity Module (USIM), the method comprising:
transmitting, to an Access and Mobility Management Function (AMF), a Registration Request message, in a case where an Operator controlled signal threshold per access technology is not set on the USIM or not applied by the UE, and
receiving, from the AMF, a Registration Accept message including information indicating the Operator controlled signal threshold per access technology.

### (Supplementary Note 15)

A method in an Access and Mobility Management Function (AMF), the method comprising:
receiving, from a user equipment (UE), a Registration Request message, and
transmitting, to the UE, a Registration Accept message including information indicating a signal threshold per access technology, the information being received from a Unified Data Management (UDM).

### (Supplementary Note 16)

A method in an a Unified Data Management (UDM), the method comprising:
receiving, from an Access and Mobility Management Function (AMF), first request message,
transmitting, to a Steering Of Roaming Application Function (SoR-AF), second request message,
receiving, from the SoR-AF, second response message including information indicating an Operator controlled signal threshold per access technology, and transmitting first response message including the information indicating the Operator controlled signal threshold per access technology received from the SOR-AF.

### REFERENCE SIGNS LIST

1 SYSTEM
3 UE
5 (R)AN node
60 RU
61 DU
62 CU
7 CORE NETWORK
70 AMF
71 SMF
72 UPF
73 PCF
74 AUSF
75 UDM
76 NSSF
20 DATA NETWORK
33 MT
35 USIM
201 SOR AF

What is claimed is:

1-16. (canceled)

17. A method performed by a user equipment (UE) roaming to a first network, the method comprising:
sending, to an Access and Mobility Management Function (AMF) located in the first network, a Registration Request message for an initial registration to retrieve information related to signal threshold per the access technology from a Unified Data Management (UDM) located in a Home Public Land Mobile Network (HPLMN);
receiving, from the AMF, a Registration Accept message comprising the signal threshold per the access technology; and
using the received signal threshold per the access technology for subsequent PLMN selections.

18. The method according to claim 17, wherein
the first network comprises either the HPLMN, or a Visited Public Land Mobile Network (VPLMN).

19. A method performed by a Unified Data Management (UDM) located in a Home Public Land Mobile Network (HPLMN), the method comprising:
receiving, from an Access and Mobility Management Function (AMF) located in a first network, a first request message, the first request message being sent by the AMF based on a Registration Request message for an initial registration being received from a User Equipment (UE), wherein
when the UE performs a Registration Procedure in the first network, the method comprises:
sending, to a first device, a second request message;
receiving, from the first device, a second response message comprising a secured packet; and
sending, to the AMF, a first response message comprising a signal threshold per an access technology being formed based on the secured packet to request the AMF to send a Registration Accept message comprising the signal threshold per the access technology to the UE.

20. The method according to claim 19, wherein
the first network comprises either the HPLMN, or a Visited Public Land Mobile Network (VPLMN).

21. A user equipment (UE) roaming to a first network, the UE comprising:
one or more memories storing instructions; and
one or more processors configured to process the instructions to control the UE to:
send, to an Access and Mobility Management Function (AMF) located in the first network, a Registration Request message for an initial registration to retrieve information related to signal threshold per the access technology from a Unified Data Management (UDM) located in a Home Public Land Mobile Network (HPLMN);
receive, from the AMF, a Registration Accept message comprising the signal threshold per the access technology; and
use the received signal threshold per the access technology for subsequent PLMN selections.

22. The UE according to claim 21, wherein
the first network comprises either the HPLMN, or a Visited Public Land Mobile Network (VPLMN).

23. A Unified Data Management (UDM) located in a Home Public Land Mobile Network (HPLMN) comprising:
one or more memories storing instructions; and
one or more processors configured to process the instructions to control the UDM to:
receive, from an Access and Mobility Management Function (AMF) located in a first network, a first request message, the first request message being sent by the AMF based on a Registration Request message for an initial registration being received from a User Equipment (UE), wherein
when the UE performs a Registration Procedure in the first network, the one or more processors are configured to process the instructions to control the UDM to:
send, to a first device, a second request message;
receive, from the first device, a second response message comprising a secured packet; and
send, to the AMF, a first response message comprising a signal threshold per an access technology being formed based on the secured packet to request the AMF to send a Registration Accept message comprising the signal threshold per the access technology to the UE.

24. The UDM according to claim 23, wherein
the first network comprises either the HPLMN, or a Visited Public Land Mobile Network (VPLMN).
